(19) United States
(12) Patent Application Publication
(10) Pub. No.: US 2023/0375405 A1
(43) Pub. Date: Nov. 23, 2023

(54) METHOD AND DEVICE FOR RECONSTRUCTING SPECTRUM, SPECTROMETER, NON-TRANSITORY COMPUTER-READABLE STORAGE MEDIUM, AND ELECTRONIC DEVICE

(71) Applicant: Shanghai Institute of Technical Physics, Chinese Academy of Sciences, Shanghai (CN)

(72) Inventors: Shaowei WANG, Shanghai (CN); Qingquan LIU, Shanghai (CN); Zhiqin YIN, Shanghai (CN); Wei LU, Shanghai (CN)

(73) Assignee: Shanghai Institute of Technical Physics, Chinese Academy of Sciences, Shanghai (CN)

(21) Appl. No.: 18/354,510

(22) Filed: Jul. 18, 2023

Related U.S. Application Data
(63) Continuation of application No. PCT/CN2023/078205, filed on Feb. 24, 2023.

(30) Foreign Application Priority Data
May 17, 2022 (CN) 202210536422.5

(51) Int. Cl. G01J 3/28

(52) U.S. Cl. CPC G01J 3/28; G01J 2003/283

(57) ABSTRACT

Disclosed are a method and a device for reconstructing a spectrum, a spectrometer, a computer-readable storage medium, and an electronic device, and solves a problem of poor anti-noise ability of the method for reconstructing a spectrum. According to a feature that a spectrum must be positive, the present application converts the negative spectral value in the spectral data to be processed into positive spectral value by the objective function, so that the anti-noise ability of an iterative solution process of the objective function may be improved, and thus accuracy of the reconstructed spectral data may be improved.

### CROSS-REFERENCE TO RELATED APPLICATIONS

This application is a continuation of International Application No. PCT/CN2023/078205, filed on Feb. 24, 2023, which claims priority to Chinese Patent Application No. 202210536422.5 filed on May 17, 2022. The entire contents of both applications are incorporated herein by reference in their entireties.

### TECHNICAL FIELD

The present application relates to the field of spectral analysis technologies, and in particular, to a method and a device for reconstructing a spectrum, a spectrometer, a non-transitory computer-readable storage medium, and an electronic device.

### BACKGROUND

Each kind of atom has a corresponding characteristic spectrum, and the corresponding characteristic spectrum may be used to identify substances or determine chemical components. At present, a reconstructed spectrometer is commonly used to measure and analyze spectra. The reconstructed spectrometer includes hardware and software. The hardware mainly includes a detector, and the software mainly includes a spectral reconstruction algorithm. The reconstructed spectrum is obtained by performing an inversion calculation on a response value according to a method for reconstructing a spectrum after the detector detects the response value. However, accuracy of the reconstructed spectrum obtained by the current method for reconstructing a spectrum is low and fails to meet requirements of users.

### SUMMARY

According to a first aspect of an embodiment of the present application, a method for reconstructing a spectrum is provided, the method is applied to a spectrometer and includes: determining spectral data to be processed; and acquiring positive spectral data by converting, by an objective function, a negative spectral value in the spectral data to be processed into a positive spectral value, determining a loss value by performing, by the objective function, loss calculation based on the positive spectral data and response value data, and acquiring reconstructed spectral data when the loss value meets a first preset condition or a number of the loss calculation meets a second preset condition, where the response value data is obtained by measuring, by the spectrometer, a spectrum to be reconstructed.

In some embodiments in combination with the first aspect of the present application, the acquiring positive spectral data by converting, by an objective function, a negative spectral value in the spectral data to be processed into a positive spectral value, determining a loss value by performing, by the objective function, loss calculation based on the positive spectral data and response value data, and acquiring reconstructed spectral data when the loss value meets a first preset condition or a number of the loss calculation meets a second preset condition includes: acquiring current positive spectral data by converting, by the objective function, the negative spectral value in current spectral data to be processed into the positive spectral value; determining, by the objective function, a current loss value and current reconstructed spectral data based on the current positive spectral data and the response value data; and adjusting the spectral data to be processed based on the current loss value and the current reconstructed spectral data, iterating the spectral data to be processed, and acquiring the reconstructed spectral data until the loss value meets the first preset condition or the number of the loss calculation meets the second preset condition.

In some embodiments in combination with the first aspect of the present application, the acquiring current positive spectral data by converting, by the objective function, the negative spectral value in current spectral data to be processed into the positive spectral value includes: acquiring the current positive spectral data by converting, by the objective function, the negative spectral value in the current spectral data to be processed into the positive spectral value by taking an absolute value of the current spectral data to be processed.

In some embodiments in combination with the first aspect of the present application, the acquiring current positive spectral data by converting, by the objective function, the negative spectral value in current spectral data to be processed into the positive spectral value includes: determining a symbol diagonal matrix of the current spectral data to be processed; and acquiring the current positive spectral data by converting, by the objective function, the negative spectral value in the current spectral data to be processed into the positive spectral value by taking a product of the current spectral data to be processed and the symbol diagonal matrix.

In some embodiments in combination with the first aspect of the present application, the determining spectral data to be processed includes: determining the current spectral data to be processed corresponding to the (k+2)^{th} cycle based on current reconstructed spectral data obtained from the k^{th} cycle and current reconstructed spectral data obtained from the (k+1)^{th} cycle, where k is a positive integer.

In some embodiments in combination with the first aspect of the present application, the determining the current spectral data to be processed corresponding to the (k+2)^{th} cycle based on current reconstructed spectral data obtained from the k^{th} cycle and current reconstructed spectral data obtained from the (k+1)^{th} cycle includes: acquiring difference data by calculating a difference between the current reconstructed spectral data obtained from the (k+1)^{th} cycle and the current reconstructed spectral data obtained from the k^{th} cycle; and determining the current spectral data to be processed corresponding to the (k+2)^{th} cycle based on the current reconstructed spectral data obtained from the (k+1)^{th} cycle, the difference data, and a preset return function.

According to a second aspect of an embodiment of the present application, a device for reconstructing a spectrum is provided, the device is applied to a spectrometer and includes: a determination module, configured to determine spectral data to be processed; and a reconstruction module, configured to acquire positive spectral data by converting, by an objective function, a negative spectral value in the spectral data to be processed into a positive spectral value, determining a loss value by performing, by the objective function, loss calculation based on the positive spectral data and response value data, and acquiring reconstructed spectral data when the loss value meets a first preset condition or a number of the loss calculation meets a second preset condition, where the response value data is obtained by measuring, by the spectrometer, a spectrum to be reconstructed.

According to a third aspect of an embodiment of the present application, a spectrometer is provided, and the spectrometer includes: a detector, configured to acquire response value data by measuring a spectrum to be reconstructed, and send the response value data to a processor; and the processor electrically connected with the detector, configured to receive the response value data, and acquire reconstructed spectral data by performing the method for reconstructing a spectrum according to the first aspect.

According to a fourth aspect of an embodiment of the present application, a computer-readable storage medium is provided, on which instructions are stored. When the instructions are executed by a processor of an electronic device, the electronic device is able to perform the method for reconstructing a spectrum according to the first aspect.

According to a fifth aspect of an embodiment of the present application, an electronic device is provided, and the electronic device includes: a processor; and a memory, configured to store computer executable instructions; where the processor is configured to perform the computer executable instructions to implement the method for reconstructing a spectrum according to the first aspect.

According to the method for reconstructing a spectrum provided by an embodiment of the present application, the positive spectral data may be acquired by converting, by an objective function, a negative spectral value in the spectral data to be processed into a positive spectral value; the loss value may be determined by performing, by the objective function, loss calculation based on the positive spectral data and response value data; the reconstructed spectral data may be acquired when the loss value meets a first preset condition or a number of the loss calculation meets a second preset condition. According to a feature that a spectrum must be positive, the present application converts the negative spectral value in the spectral data to be processed into positive spectral value by the objective function, so that the anti-noise ability of an iterative solution process of the objective function may be improved, and thus accuracy of the reconstructed spectral data may be improved. In addition, the present application converts the negative spectral value in the spectral data to be processed into positive spectral value by the objective function without adding constraints to the objective function, and avoids turning a unconstrained problem into a constrained problem, so that the accuracy of the obtained reconstructed spectral data may be further improved, and convergence efficiency of the objective function may be improved.

### BRIEF DESCRIPTION OF THE DRAWINGS

FIG. 1A is a schematic diagram of an applicable scenario of a method for reconstructing a spectrum according to an embodiment of the present application.

FIG. 1B is a schematic diagram of an applicable scenario of a method for reconstructing a spectrum according to another embodiment of the present application.

FIG. 2 is a schematic flowchart of a method for reconstructing a spectrum according to an embodiment of the present application.

FIG. 3 is a schematic flowchart of a method for reconstructing a spectrum according to another embodiment of the present application.

FIG. 4 is a schematic flowchart of a method for reconstructing a spectrum according to another embodiment of the present application.

FIG. 5 is a schematic flowchart of a method for reconstructing a spectrum according to another embodiment of the present application.

FIG. 6 is a schematic flowchart of a method for reconstructing a spectrum according to another embodiment of the present application.

FIG. 7 is a schematic flowchart of a method for reconstructing a spectrum according to another embodiment of the present application.

FIG. 8 is a schematic flowchart of a method for reconstructing a spectrum according to another embodiment of the present application.

FIG. 9 is a schematic diagram of a measuring principle of a spectrometer according to an embodiment of the present application.

FIG. 10 is a schematic structural diagram of an integrated filter according to an embodiment of the present application.

FIG. 11 is a response curve according to an embodiment of the present application.

FIG. 12A is a reconstructed spectrum and an incident spectrum obtained by an integrated filter shown in FIG. 10 and the Tikhonov regularization method.

FIG. 12B is a reconstructed spectrum and an incident spectrum obtained by an integrated filter shown in FIG. 10 and a method for reconstructing a spectrum according to the present application.

FIG. 13 is a schematic structural diagram of a detector according to an embodiment of the present application.

FIG. 14 is a response curve according to an embodiment of the present application.

FIG. 15A is a reconstructed spectrum and an incident spectrum obtained by a detector shown in FIG. 13 and the Tikhonov regularization method.

FIG. 15B is a reconstructed spectrum and an incident spectrum obtained by a detector shown in FIG. 13 and a method for reconstructing a spectrum according to the present application.

FIG. 16 is a schematic structural diagram of a device for reconstructing a spectrum according to an embodiment of the present application.

FIG. 17 is a schematic structural diagram of a device for reconstructing a spectrum according to another embodiment of the present application.

FIG. 18 is a schematic structural diagram of a device for reconstructing a spectrum according to another embodiment of the present application.

FIG. 19 is a schematic structural diagram of a device for reconstructing a spectrum according to another embodiment of the present application.

FIG. 20 is a schematic structural diagram of a device for reconstructing a spectrum according to another embodiment of the present application.

FIG. 21 is a schematic structural diagram of a device for reconstructing a spectrum according to another embodiment of the present application.

FIG. 22 is a schematic structural diagram of a device for reconstructing a spectrum according to another embodiment of the present application.

FIG. 23 is a schematic structural diagram of an electronic device according to an embodiment of the present application.

### DETAILED DESCRIPTION OF THE EMBODIMENTS

The technical solutions in the embodiments of the present application are described clearly and completely below with reference to the drawings of the embodiments of the present application. Apparently, the described embodiments are only a part, but not all of the embodiments of the present application. All other embodiments that may be obtained by those of ordinary skill in the art based on the embodiments in the present application without any inventive efforts fall into the protection scope of the present application.

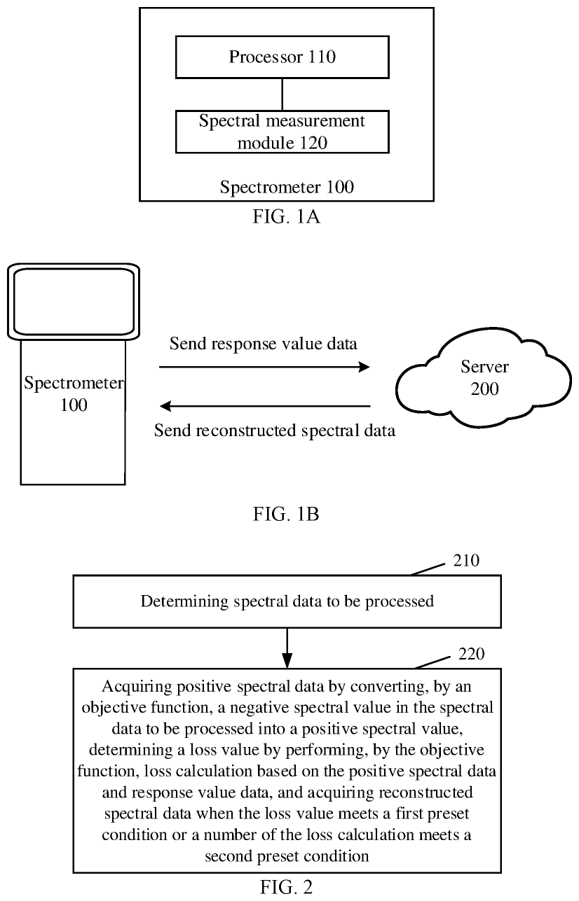

FIG. 1A is a schematic diagram of an applicable scenario of a method for reconstructing a spectrum according to an embodiment of the present application. The scenario shown in FIG. 1A includes a processor 110 and a spectral measurement module 120 in a spectrometer 100. The spectral measurement module 120 is communication connected to the processor 110. Specifically, the processor 110 is used to determine spectral data to be processed; and acquire positive spectral data by converting, by an objective function, a negative spectral value in the spectral data to be processed into a positive spectral value, determine a loss value by performing, by the objective function, loss calculation based on the positive spectral data and response value data, and acquire reconstructed spectral data when the loss value meets a first preset condition or a number of the loss calculation meets a second preset condition. The spectral measurement module 120 is used to acquire response value data by measuring a spectrum to be reconstructed, and send the response value data to the processor 110, so that the processor 110 can perform the above operations.

FIG. 1B is a schematic diagram of an applicable scenario of a method for reconstructing a spectrum according to another embodiment of the present application. The scenario shown in FIG. 1B includes a spectrometer 100 and a server 200. The spectrometer 100 acquires response value data by measuring a spectrum to be reconstructed, and sends the response value data to the server 200. The server 200 receives the response value data, and determines spectral data to be processed; and acquires positive spectral data by converting, by an objective function, a negative spectral value in the spectral data to be processed into a positive spectral value, determines a loss value by performing, by the objective function, loss calculation based on the positive spectral data and response value data, and acquires reconstructed spectral data when the loss value meets a first preset condition or a number of the loss calculation meets a second preset condition.

In an embodiment of the present application, the server 200 may also send the reconstructed spectral data to the spectrometer 100 after acquiring the reconstructed spectral data, so that the reconstructed spectral data may be displayed on the spectrometer 100.

FIG. 2 is a schematic flowchart of a method for reconstructing a spectrum according to an embodiment of the present application. As shown in FIG. 2, the method for reconstructing a spectrum includes the following steps.

Step 210: Determining spectral data to be processed.

Specifically, the spectral data to be processed may be the spectral data obtained by initialization. For example, the spectral data to be processed may be the spectral data obtained by initialization methods such as random value initialization, random positive number initialization, and Tikhonov initialization. The spectral data to be processed may be a spectral matrix, and one of the elements in the spectral matrix represents the wavelength of a light wave.

Step 220: Acquiring positive spectral data by converting, by an objective function, a negative spectral value in the spectral data to be processed into a positive spectral value, determining a loss value by performing, by the objective function, loss calculation based on the positive spectral data and response value data, and acquiring reconstructed spectral data when the loss value meets a first preset condition or a number of the loss calculation meets a second preset condition.

Specifically, the response value data is obtained by measuring, by the spectrometer, a spectrum to be reconstructed. The response value data may be a response value matrix. The spectrum to be reconstructed is the spectrum that should be measured. The reconstructed spectral data may be the spectral data obtained by optimizing, by the objective function, the spectral data to be processed based on the response value data. The objective function may represent the functional relationship between the spectral data to be processed and the response value data. The objective function may also convert negative spectral values in the spectral data to be processed into positive spectral values. The negative spectral values in the spectral data to be processed may be noise in the spectral data to be processed. In an embodiment of the present application, the positive spectral data may be obtained by taking an absolute value of the spectral value in the spectral data to be processed, so that the negative spectral value in the spectral data to be processed may be converted into a positive spectral value. In an embodiment of the present application, the symbol diagonal matrix of the spectral data to be processed may be determined first, and then the positive spectral data may be obtained by taking an absolute value of the spectral value in the spectral data to be processed, so that the negative spectral value in the spectral data to be processed may be converted into a positive spectral value by the symbol diagonal matrix.

Specifically, the objective function may include an absolute value operator, which is used to convert the negative spectral value in the spectral data to be processed into a positive spectral value. That is, the negative spectral value in the spectral data to be processed may be converted into a positive spectral value by introducing an absolute value operator into the objective function.

Specifically, determining the loss value by performing, by the objective function, loss calculation based on the positive spectral data and the response value data could be performing loss calculation by the method of taking a difference between the response value data and the positive spectral data to determine the loss value. The first preset condition may be a preset threshold. If the loss value meets the preset threshold, the reconstructed spectral data may be obtained. The first preset condition may also be a preset convergence condition of the loss value. If the loss value meets the preset convergence condition of the loss value, the reconstructed spectral data may be obtained. The preset convergence condition of the loss value may be that the loss values obtained from several consecutive calculations are very close, or even the loss values obtained from the next few calculations are greater than the loss values obtained from the previous few calculations. The second preset condition may be a preset number of loss calculations. If the number of loss calculations meets the preset number of loss calculations, the reconstructed spectral data may be obtained. The user may determine the first preset condition and the second preset condition based on the actual needs, which is not specifically limited in the present application.

The method for reconstructing a spectrum according to an embodiment of the present application uses the objective function to acquire positive spectral data by converting a negative spectral value in the spectral data to be processed into a positive spectral value, to determine a loss value by performing loss calculation based on the positive spectral data and response value data, and acquire reconstructed spectral data when the loss value meets a first preset condition or a number of the loss calculation meets a second preset condition. The poor anti-noise ability of the iterative solution process of the objective function is because the negative spectral values in the spectral data to be processed are interference data. Therefore, the present application uses the objective function to convert the negative spectral value in the spectral data to be processed into a positive spectral value, so that the anti-noise ability of the iterative solution process of the objective function may be improved, and thus the accuracy of the reconstructed spectral data may be improved. In addition, the present application converts the negative spectral value in the spectral data to be processed into positive spectral value by the objective function without adding constraints to the objective function, and avoids the conversion of non-constraint problems into constraint problems, so that the accuracy of the obtained reconstructed spectral data may be further improved, and the convergence efficiency of the objective function may be improved.

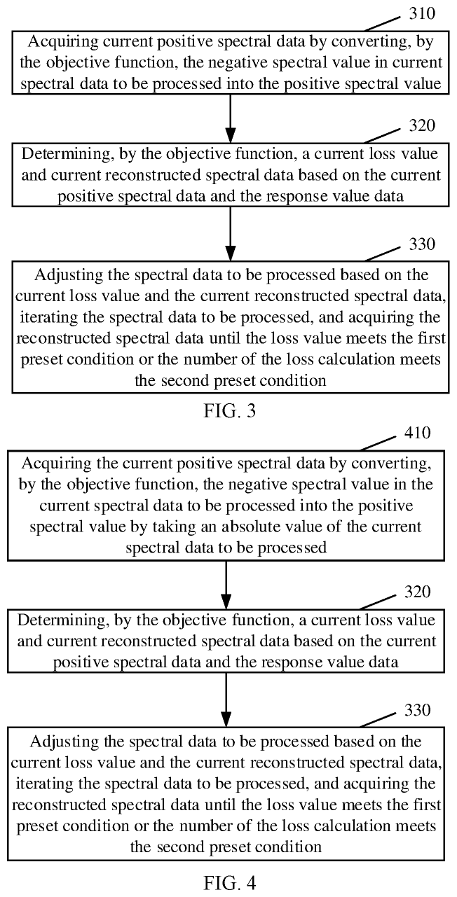

FIG. 3 is a schematic flowchart of a method for reconstructing a spectrum according to another embodiment of the present application. The embodiment shown in FIG. 3 is extended on the basis of the embodiment shown in FIG. 2. The differences between the embodiment shown in FIG. 3 and the embodiment shown in FIG. 2 are described in detail below and the similarities are not described again.

As shown in FIG. 3, in an embodiment of the present application, the acquiring positive spectral data by converting, by an objective function, a negative spectral value in the spectral data to be processed into a positive spectral value, determining a loss value by performing, by the objective function, loss calculation based on the positive spectral data and response value data, and acquiring reconstructed spectral data when the loss value meets a first preset condition or a number of the loss calculation meets a second preset condition includes the following steps.

Step 310: Acquiring current positive spectral data by converting, by the objective function, the negative spectral value in current spectral data to be processed into the positive spectral value.

Specifically, the current spectral data to be processed refers to the spectral data currently being processed. The current positive spectral data refers to the currently obtained positive spectral data.

For example, the objective function S may be expressed by the equation (1).

$${min}_{S} {‖ I - TQ \vert {X}_{k} \vert ‖}^{2} + α {‖ {LX}_{k} ‖}_{n}^{m} \qquad ( 1 )$$

where I represents the response value data, T represents a reconstruction matrix, Q represents a preprocessing matrix, L represents a regularization matrix, and Xₖ represents the current spectral data to be processed corresponding to the k^{th} cycle, α∥LXₖ∥ₙ^{m} represents a regularization term, α represents a regularization coefficient, m represents idempotent, and n represents a type of norm. T, Q, L and m, n may be obtained through pre-calibration or pre-setting, and the values are not specifically limited in the present application.

The equation (1) indicates that Xₖ may be adjusted iteratively so that S may become a smaller value, even the smallest value. |Xₖ| represents the absolute value of Xₖ, so that the negative spectral value in the spectral data to be processed may be converted into positive spectral value, and the positive spectral data may be obtained. The equation (1) may also be without preprocessing matrix Q and regularization matrix L. Even the equation (1) may be without regularization term α∥LXₖ∥ₙ^{m}.

Step 320: Determining, by the objective function, a current loss value and current reconstructed spectral data based on the current positive spectral data and the response value data.

For example, the current loss value may be calculated by the equation (1). The spectral data to be processed for calculating the current loss value is the current reconstructed spectral data.

Step 330: Adjusting the spectral data to be processed based on the current loss value and the current reconstructed spectral data, iterating the spectral data to be processed, and acquiring the reconstructed spectral data until the loss value meets the first preset condition or the number of the loss calculation meets the second preset condition.

Specifically, the spectral data to be processed may be continuously adjusted and iterated until the loss value meets the first preset condition or the number of loss calculations meets the second preset condition, and the current reconstructed spectral data for calculating the current loss value is determined as the reconstructed spectral data.

Specifically, after determining, by the objective function, the current loss value based on the current positive spectral data and response value data, the current spectral data to be processed may be determined as the current reconstructed spectral data. That is, for each cycle, after the loss value is calculated in this cycle, the spectral data to be processed in this cycle is determined as the reconstructed spectral data of this cycle.

By adjusting the spectral data to be processed based on the current loss value and the current reconstructed spectral data, iterating the spectral data to be processed, and acquiring the reconstructed spectral data until the loss value meets the first preset condition or the number of the loss calculation meets the second preset condition, the more accurate reconstructed spectral data may be determined from the corresponding reconstructed spectral data of multiple iterations, so that the accuracy of the final reconstructed spectral data may be further improved.

FIG. 4 is a schematic flowchart of a method for reconstructing a spectrum according to another embodiment of the present application. The embodiment shown in FIG. 4 is extended on the basis of the embodiment shown in FIG. 3. The differences between the embodiment shown in FIG. 4 and the embodiment shown in FIG. 3 are described in detail below and the similarities are not described again.

As shown in FIG. 4, in an embodiment of the present application, the acquiring current positive spectral data by converting, by the objective function, the negative spectral value in current spectral data to be processed into the positive spectral value includes the following step.

Step 410: Acquiring the current positive spectral data by converting, by the objective function, the negative spectral value in the current spectral data to be processed into the positive spectral value by taking an absolute value of the current spectral data to be processed.

In practical applications, as shown in the equation (1), the objective function may convert the negative spectral value in the current spectral data to be processed into the positive spectral value by taking an absolute value of the current spectral data to be processed to obtain the current positive spectral data. The method of taking absolute value is simple and accurate, so that the efficiency of solving the objective function may be improved.

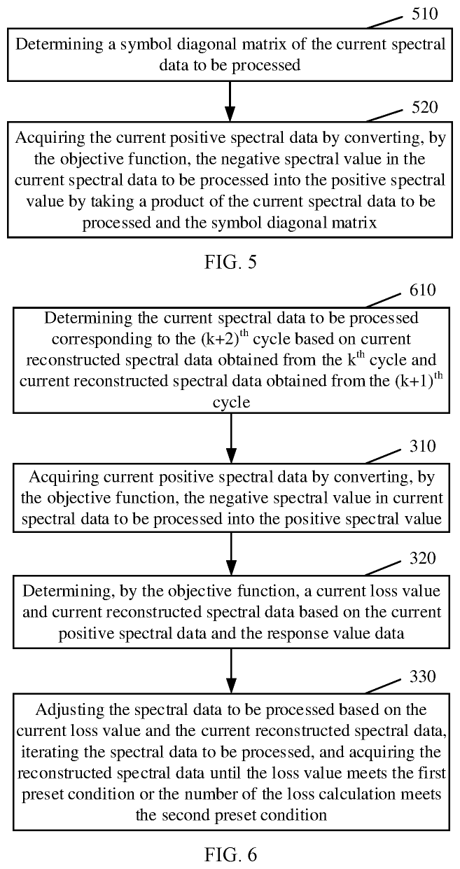

FIG. 5 is a schematic flowchart of a method for reconstructing a spectrum according to another embodiment of the present application. The embodiment shown in FIG. 5 is extended on the basis of the embodiment shown in FIG. 3. The differences between the embodiment shown in FIG. 5 and the embodiment shown in FIG. 3 are described in detail below and the similarities are not described again.

As shown in FIG. 5, in an embodiment of the present application, the acquiring current positive spectral data by converting, by the objective function, the negative spectral value in current spectral data to be processed into the positive spectral value includes the following steps.

Step 510: Determining a symbol diagonal matrix of the current spectral data to be processed.

Specifically, the symbol diagonal matrix may be represented by Aₖ. The symbol diagonal matrix Aₖ of the spectral data to be processed may be calculated by the equation (2).

Aₖ←diag(sign(Xₖ)) (2)

The subscript k represents the k^{th} cycle.

Step 520: Acquiring the current positive spectral data by converting, by the objective function, the negative spectral value in the current spectral data to be processed into the positive spectral value by taking a product of the current spectral data to be processed and the symbol diagonal matrix.

In practical applications, the objective function may convert the negative spectral value in the current spectral data to be processed into the positive spectral value by taking a product of the current spectral data to be processed X and the symbol diagonal matrix A to obtain the current positive spectral data. The method is simple and efficient.

FIG. 6 is a schematic flowchart of a method for reconstructing a spectrum according to another embodiment of the present application. The embodiment shown in FIG. 6 is extended on the basis of the embodiment shown in FIG. 3. The differences between the embodiment shown in FIG. 6 and the embodiment shown in FIG. 3 are described in detail below and the similarities are not described again.

As shown in FIG. 6, in an embodiment of the present application, the determining spectral data to be processed includes the following step.

Step 610: Determining the current spectral data to be processed corresponding to the (k+2)^{th} cycle based on current reconstructed spectral data obtained from the k^{th} cycle and current reconstructed spectral data obtained from the (k+1)^{th} cycle.

Specifically, k is a positive integer. For example, when k=1, (k+1)=2, (k+2)=3, that is, determining the current spectral data to be processed corresponding to the 3^{rd} cycle based on current reconstructed spectral data obtained from the 1^{st} cycle and current reconstructed spectral data obtained from the 2^{nd} cycle.

In practical applications, by determining the current spectral data to be processed corresponding to the (k+2)^{th} cycle based on current reconstructed spectral data obtained from the k^{th} cycle and current reconstructed spectral data obtained from the (k+1)^{th} cycle, the current spectral data to be processed in the subsequent cycles may refer to the current reconstructed spectral data obtained in the previous two cycles, so that the accuracy of current spectral data to be processed in the subsequent cycles may be improved.

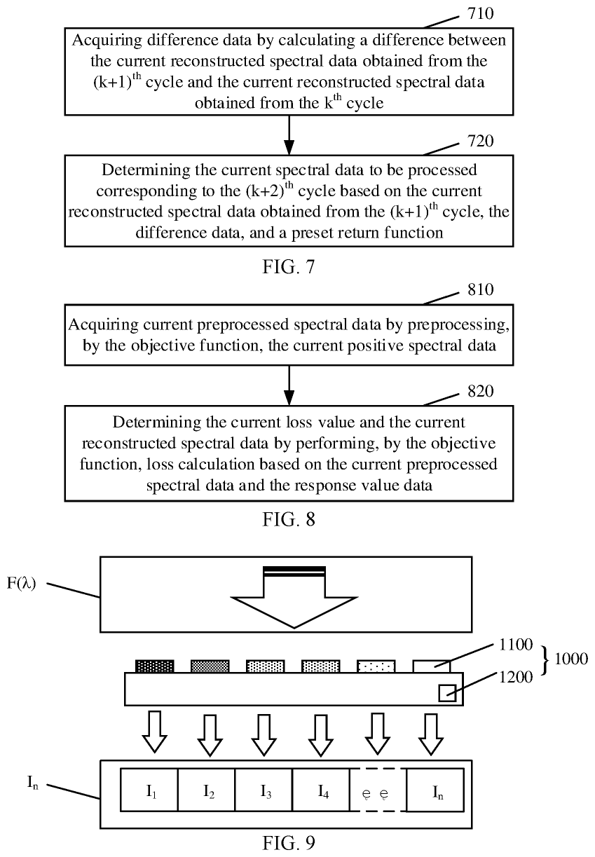

FIG. 7 is a schematic flowchart of a method for reconstructing a spectrum according to another embodiment of the present application. The embodiment shown in FIG. 7 is extended on the basis of the embodiment shown in FIG. 6. The differences between the embodiment shown in FIG. 7 and the embodiment shown in FIG. 6 are described in detail below and the similarities are not described again.

As shown in FIG. 7, in an embodiment of the present application, the determining the current spectral data to be processed corresponding to the (k+2)^{th} cycle based on current reconstructed spectral data obtained from the k^{th} cycle and current reconstructed spectral data obtained from the (k+1)^{th} cycle includes the following steps.

Step 710: Acquiring difference data by calculating a difference between the current reconstructed spectral data obtained from the (k+1)^{th} cycle and the current reconstructed spectral data obtained from the k^{th} cycle.

Specifically, Yₖ₊₁ may represent the current reconstructed spectral data obtained from the (k+1)^{th} cycle, and Yₖ may represent the current reconstructed spectral data obtained from the k^{th} cycle.

Step 720: Determining the current spectral data to be processed corresponding to the (k+2)^{th} cycle based on the current reconstructed spectral data obtained from the (k+1)^{th} cycle, the difference data, and a preset return function.

Specifically, Yₖ₊₂ may represent the current reconstructed spectral data obtained from the (k+2)^{th} cycle. For example, the current spectral data to be processed Xₖ₊₂ corresponding to the (k+2)^{th} cycle may be determined by the equation (3) (namely, the preset return function).

Xₖ₊₂←Pₖ₊₂−l[Aₖ₊₂′T′Q′(TQAₖ₊₂Pₖ₊₂Pₖ₊₂−I)−grad(α∥LPₖ₊₂∥ₙ^{m})] (3)

where, Pₖ₊₂ is the intermediate value, which may be calculated by the equation (4). Aₖ₊₂ represents the symbol diagonal matrix of the current spectral data to be processed corresponding to the (k+2)^{th} cycle, therefore, it may be obtained by the equation (2). l represents the iteration step, and grad represents the gradient function.

Pₖ₊₂←Yₖ+βₖ₊₂(Yₖ₊₁−Yₖ) (4)
where, βₖ₊₂ represents the preset return function corresponding to the (k+2)^{th} cycle.

After the (k+2)^{th} cycle ends, the Yₖ₊₂ obtained is equal to Xₖ₊₂.

By acquiring difference data by calculating a difference between the current reconstructed spectral data obtained from the (k+1)^{th} cycle and the current reconstructed spectral data obtained from the k^{th} cycle, and determining the current spectral data to be processed corresponding to the (k+2)^{th} cycle based on the current reconstructed spectral data obtained from the (k+1)^{th} cycle, the difference data, and a preset return function, the spectral data to be processed may be optimized, and the accuracy of the reconstructed spectral data may be improved through multiple iterations.

In an embodiment of the present application, when k=1, namely the first cycle, the Tikhonov regularization assignment may be used to initialize the assignment of X₁. Specifically, X₁ may be initialized and assigned by the equation (5).

X₁=(T^{H}T+γJ)⁻¹T^{H}I (5)
where, T represents the reconstruction matrix like Tin equation (1). The superscript H is used to indicate that T^{H} is the conjugate transpose matrix of T, and J represents the identity matrix with the same dimension as T^{H}T, γ is the Tikhonov regularization coefficient. γ may be preset.

FIG. 8 is a schematic flowchart of a method for reconstructing a spectrum according to another embodiment of the present application. The embodiment shown in FIG. 8 is extended on the basis of the embodiment shown in FIG. 3. The differences between the embodiment shown in FIG. 8 and the embodiment shown in FIG. 3 are described in detail below and the similarities are not described again.

As shown in FIG. 8, in an embodiment of the present application, the determining, by the objective function, a current loss value and current reconstructed spectral data based on the current positive spectral data and the response value data includes the following steps.

Step 810: Acquiring current preprocessed spectral data by preprocessing, by the objective function, the current positive spectral data.

Specifically, the preprocessing matrix Q in the equation (1) may be used to preprocess the current positive spectral data to obtain the current preprocessed spectral data. The preprocessing matrix Q may be a Fourier transform matrix, or other matrices that may realize discretization, which is not specifically limited in the present application.

Step 820: Determining the current loss value and the current reconstructed spectral data by performing, by the objective function, loss calculation based on the current preprocessed spectral data and the response value data.

The continuous spectrum may be discretized by preprocessing, by the objective function, the current positive spectral data, so that the amount of data may be reduced and the computational efficiency may be improved.

FIG. 9 is a schematic diagram of a measuring principle of a spectrometer according to an embodiment of the present application. As shown in FIG. 9, a spectrometer 1000 includes a detector 1100 and a processor 1200. The detector 1100 is configured to acquire response value data (in this embodiment, the response value data may be the response value matrix Iₙ) by measuring a spectrum to be reconstructed F(λ), and send the response value data to the processor 1200. The processor 1200 is electrically connected with the detector 1100, and is configured to receive the response value data, and acquire reconstructed spectral data by performing the method for reconstructing a spectrum according to the above embodiments. The detector 1100 may include an integrated filter and a photosensitive chip. The photosensitive chip may be a complementary metal oxide semiconductor (CMOS) photosensitive chip, or a charge-coupled device (CCD).

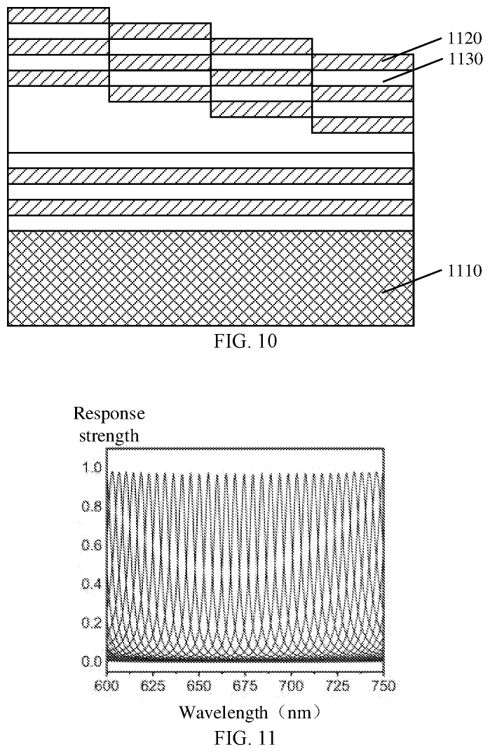

FIG. 10 is a schematic structural diagram of an integrated filter according to an embodiment of the present application. As shown in FIG. 10, the integrated filter includes a substrate 1110, a titanium dioxide film 1120 and a silicon dioxide film 1130. The titanium dioxide film 1120 and the silicon dioxide film 1130 may be set crossover. The specific thickness and number of layers of the titanium dioxide film 1120 and the silicon dioxide film 1130 may be set according to the actual needs, which are not specifically limited in the present application.

Specifically, the integrated filter may be represented by the Sub|(HL)⁵M(HL)⁵ film. Where Sub represents substrate 1110. H represents the titanium dioxide (TiO₂) film with a thickness of 78 nm, and L represents the first silicon dioxide (SiO₂) film 1121 with a thickness of 115 nm. M represents the second silicon dioxide film 1122 beyond L. The substrate 1110 may be a glass substrate, a quartz substrate, a gem substrate, and more specifically, a k9 glass substrate in the international standard classification.

The appropriate thickness of the second silicon dioxide film 1122 may be determined through an experiment, so that the transmission peak of the integrated filter may be increased from 600 nm to 750 nm with a separation of 0.5 nm, that is, 301 filters in total.

By the integrated filter and photosensitive chip in the detector 1100, the response curve shown in FIG. 11 may be obtained, and the reconstruction matrix Tin the above embodiments may be obtained by processing the response curve. The condition number t of T is 2.7×10⁶ by calculation. The condition number t may be calculated by the equation (6).

t=∥T∥·∥T⁻¹∥ (6)

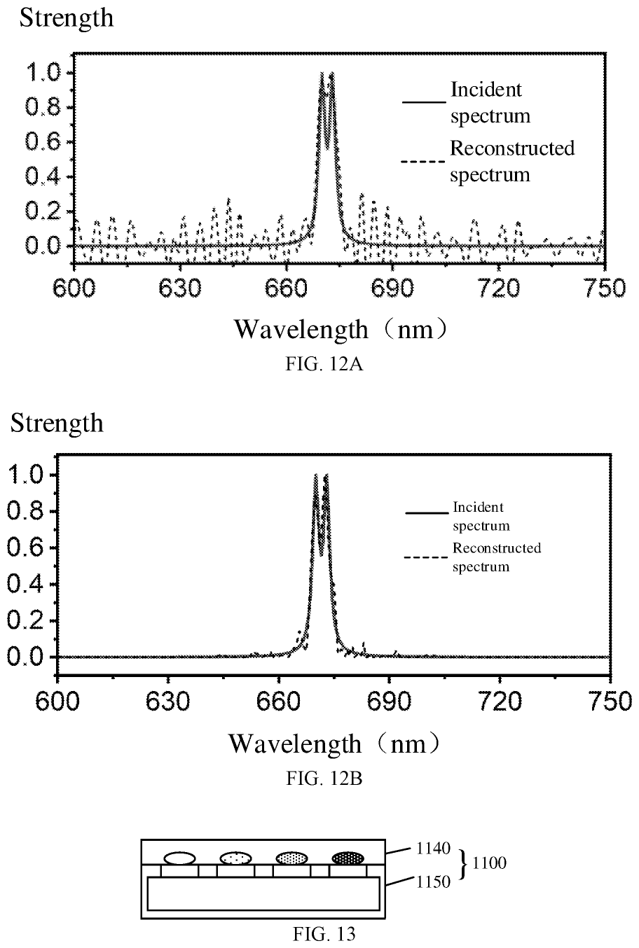

The spectrum to be reconstructed F(λ) (namely, the incident spectrum of the embodiment) is a curve with a peak separation of 3 nm, and it is assumed that the detector has 1% Gaussian white noise. In FIG. 12A, the solid line is the incident spectrum, and the dotted line is the reconstructed spectrum obtained by an integrated filter shown in FIG. 10 and the Tikhonov regularization method. In FIG. 12B, the solid line is the incident spectrum, and the dotted line is the reconstructed spectrum obtained by an integrated filter shown in FIG. 10 and a method for reconstructing a spectrum according to the present application. It may be seen that the reconstructed spectrum obtained by the method for reconstructing a spectrum according to the present application is closer to the incident spectrum, that is, the reconstructed spectrum obtained by the method for reconstructing a spectrum according to the present application is more accurate. More specifically, the mean variance between the reconstructed spectrum obtained by the method for reconstructing a spectrum of the present application and the incident spectrum is only ¼ of the mean variance between the reconstructed spectrum obtained by the Tikhonov method and the incident spectrum. Therefore, the method for reconstructing a spectrum of the present application has better anti-noise ability.

FIG. 13 is a schematic structural diagram of a detector according to an embodiment of the present application. As shown in FIG. 13, the detector 1100 includes a quantum dot layer 1140 and a photosensitive element 1150.

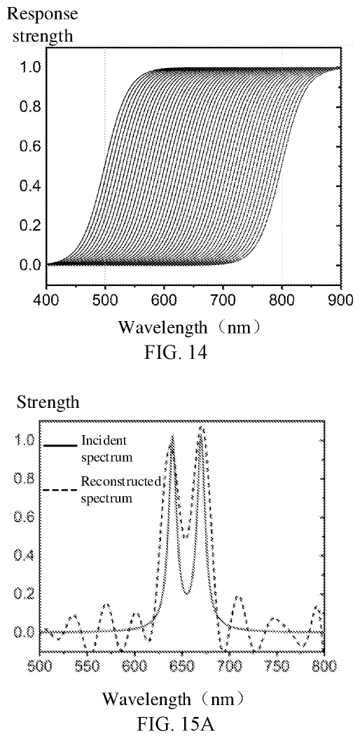

Specifically, the material of the quantum dot layer 1140 may be Cs2SnX6. X represents halogen elements Cl, Br or I. By changing the composition of halogen elements, the band gap of quantum dot materials may be adjusted to obtain different transmission spectra. The response curve shown in FIG. 14 may be obtained by the detector 1100. The reconstruction matrix Tin the above embodiments may be obtained by processing the response curve corresponding to the wavelength of 500 nm to 800 nm in the response curve shown in FIG. 14. The condition number t of T is 1.9×10²¹ by calculation. The condition number t may be calculated by formula (6). The response curve shown in FIG. 14 is a response curve of S-type light with gradually increased central peak.

The spectrum to be reconstructed F(λ) (namely, the incident spectrum of the present embodiment) is a curve with a peak separation of 30 nm, and it is assumed that the detector has 0.1% Gaussian white noise. In FIG. 15A, the solid line is the incident spectrum, and the dotted line is the reconstructed spectrum obtained by a detector shown in FIG. 13 and the Tikhonov regularization method. In FIG. 15B, the solid line is the incident spectrum, and the dotted line is the reconstructed spectrum obtained by a detector shown in FIG. 13 and a method for reconstructing a spectrum according to the present application. It may be seen that the reconstructed spectrum obtained by the method for reconstructing a spectrum according to the present application is closer to the incident spectrum, that is, the reconstructed spectrum obtained by the method for reconstructing a spectrum according to the present application is more accurate. More specifically, the mean variance between the reconstructed spectrum obtained by the method for reconstructing a spectrum of the present application and the incident spectrum is only ¼ of the mean variance between the reconstructed spectrum obtained by the Tikhonov method and the incident spectrum. Therefore, the method for reconstructing a spectrum of the present application has better anti-noise ability.

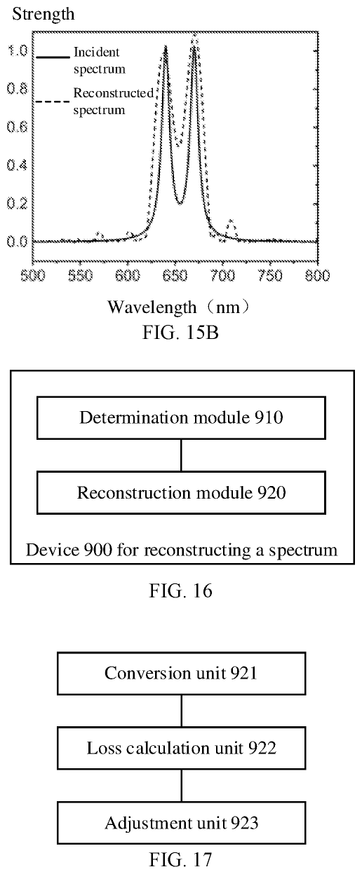

The method embodiments of the present application are described in detail above with reference to FIG. 2 to FIG. 8, and the device embodiments of the present application are described in detail below with reference to FIG. 16 to FIG. 22. It should be understood that the description of the method embodiments corresponds to the description of the device embodiments. Therefore, the part not described in detail may refer to the method embodiments.

FIG. 16 is a schematic structural diagram of a device for reconstructing a spectrum according to an embodiment of the present application. As shown in FIG. 16, the device 900 for reconstructing a spectrum according to an embodiment of the present application includes a determination module 910 and a reconstruction module 920.

Specifically, the determination module 910 is configured to determine spectral data to be processed; and the reconstruction module 920 is configured to acquire positive spectral data by converting, by an objective function, a negative spectral value in the spectral data to be processed into a positive spectral value, determining a loss value by performing, by the objective function, loss calculation based on the positive spectral data and response value data, and acquiring reconstructed spectral data when the loss value meets a first preset condition or a number of the loss calculation meets a second preset condition, where the response value data is obtained by measuring, by the spectrometer, a spectrum to be reconstructed.

FIG. 17 is a schematic structural diagram of a device for reconstructing a spectrum according to another embodiment of the present application. The embodiment shown in FIG. 17 is extended on the basis of the embodiment shown in FIG. 16. The differences between the embodiment shown in FIG. 17 and the embodiment shown in FIG. 16 are described in detail below and the similarities are not described again.

As shown in FIG. 17, the reconstruction module 920 according to an embodiment of the present application includes a conversion unit 921, a loss calculation unit 922, and an adjustment unit 923.

Specifically, the conversion unit 921 is configured to convert, by an objective function, a negative spectral value in the spectral data to be processed into a positive spectral value. The loss calculation unit 922 is configured to determine a loss value by performing, by the objective function, loss calculation based on the positive spectral data and response value data. And the adjustment unit 923 is configured to acquire reconstructed spectral data when the loss value meets a first preset condition or a number of the loss calculation meets a second preset condition.

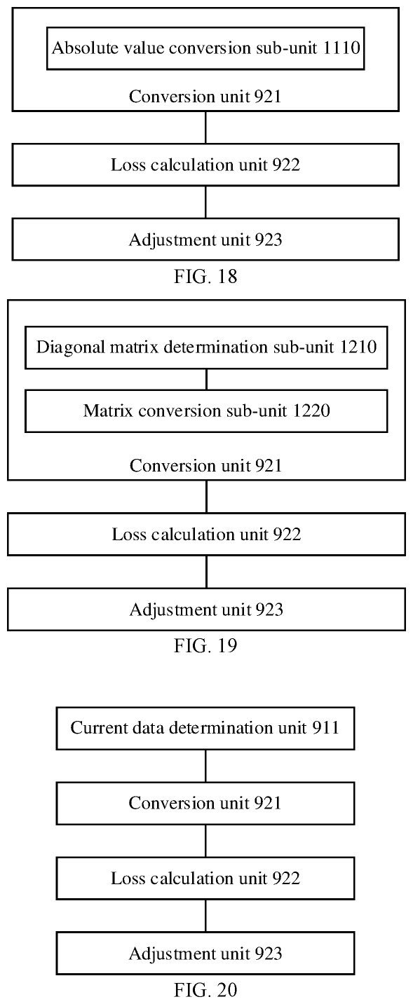

FIG. 18 is a schematic structural diagram of a device for reconstructing a spectrum according to another embodiment of the present application. The embodiment shown in FIG. 18 is extended on the basis of the embodiment shown in FIG. 17. The differences between the embodiment shown in FIG. 18 and the embodiment shown in FIG. 17 are described in detail below and the similarities are not described again.

As shown in FIG. 18, the conversion unit 921 according to an embodiment of the present application includes an absolute value conversion sub-unit 1110.

Specifically, the absolute value conversion sub-unit 1110 is configured to acquire the current positive spectral data by converting, by the objective function, the negative spectral value in the current spectral data to be processed into the positive spectral value by taking an absolute value of the current spectral data to be processed.

FIG. 19 is a schematic structural diagram of a device for reconstructing a spectrum according to another embodiment of the present application. The embodiment shown in FIG. 19 is extended on the basis of the embodiment shown in FIG. 17. The differences between the embodiment shown in FIG. 19 and the embodiment shown in FIG. 17 are described in detail below and the similarities are not described again.

As shown in FIG. 19, the conversion unit 921 according to an embodiment of the present application includes a diagonal matrix determination sub-unit 1210 and a matrix conversion sub-unit 1220.

Specifically, the diagonal matrix determination sub-unit 1210 is configured to determine a symbol diagonal matrix of the current spectral data to be processed. The matrix conversion sub-unit 1220 is configured to acquire the current positive spectral data by converting, by the objective function, the negative spectral value in the current spectral data to be processed into the positive spectral value by taking a product of the current spectral data to be processed and the symbol diagonal matrix.

FIG. 20 is a schematic structural diagram of a device for reconstructing a spectrum according to another embodiment of the present application. The embodiment shown in FIG. 20 is extended on the basis of the embodiment shown in FIG. 17. The differences between the embodiment shown in FIG. 20 and the embodiment shown in FIG. 17 are described in detail below and the similarities are not described again.

As shown in FIG. 20, the determination module 910 according to an embodiment of the present application includes a current data determination unit 911.

Specifically, the current data determination unit 911 is configured to determine the current spectral data to be processed corresponding to the (k+2)^{th} cycle based on current reconstructed spectral data obtained from the k^{th} cycle and current reconstructed spectral data obtained from the (k+1)^{th} cycle, where k is a positive integer.

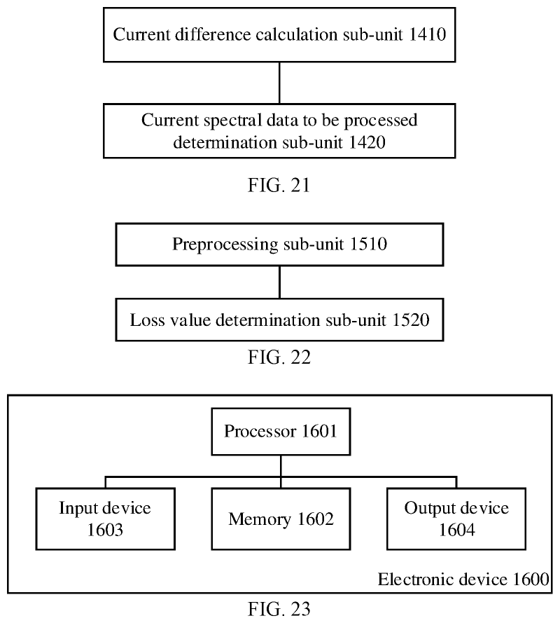

FIG. 21 is a schematic structural diagram of a device for reconstructing a spectrum according to another embodiment of the present application. The embodiment shown in FIG. 21 is extended on the basis of the embodiment shown in FIG. 20. The differences between the embodiment shown in FIG. 21 and the embodiment shown in FIG. 20 are described in detail below and the similarities are not described again.

As shown in FIG. 21, the current data determination unit 911 according to an embodiment of the present application includes a current difference calculation sub-unit 1410 and a current spectral data to be processed determination sub-unit 1420.

Specifically, the current difference calculation sub-unit 1410 is configured to acquire difference data by calculating a difference between the current reconstructed spectral data obtained from the (k+1)^{th} cycle and the current reconstructed spectral data obtained from the k^{th} cycle. The current spectral data to be processed determination sub-unit 1420 is configured to determine the current spectral data to be processed corresponding to the (k+2)^{th} cycle based on the current reconstructed spectral data obtained from the (k+1)^{th} cycle, the difference data, and a preset return function.

FIG. 22 is a schematic structural diagram of a device for reconstructing a spectrum according to another embodiment of the present application. The embodiment shown in FIG. 22 is extended on the basis of the embodiment shown in FIG. 17. The differences between the embodiment shown in FIG. 22 and the embodiment shown in FIG. 17 are described in detail below and the similarities are not described again.

As shown in FIG. 22, the loss calculation unit 922 according to an embodiment of the present application includes a preprocessing sub-unit 1510 and a loss value determination sub-unit 1520.

Specifically, the preprocessing sub-unit 1510 is configured to acquire current preprocessed spectral data by preprocessing, by the objective function, the current positive spectral data. The loss value determination sub-unit 1520 is configured to determine the current loss value and the current reconstructed spectral data by performing, by the objective function, loss calculation based on the current preprocessed spectral data and the response value data.

The operation and function of the determination module 910 and the reconstruction module 920 in the device for reconstructing a spectrum with reference to FIG. 16 to FIG. 22, the conversion unit 921, the loss calculation unit 922, and the adjustment unit 923 in the reconstruction module 920, the absolute value conversion sub-unit 1110, the diagonal matrix determination sub-unit 1210, and the matrix conversion sub-unit 1220 in the conversion unit 921, the current data determination unit 911 in the determination module 910, the current difference calculation sub-unit 1410 and the current spectral data to be processed determination sub-unit 1420 in the current data determination unit 911, and the preprocessing sub-unit 1510 and the loss value determination sub-unit 1520 in the loss calculation unit 922 may refer to the method for reconstructing a spectrum with reference to FIG. 2 to FIG. 8. In order to avoid repetition, the similarities are not described again.

FIG. 23 is a schematic structural diagram of an electronic device according to an embodiment of the present application. As shown in FIG. 23, the electronic device 1600 includes: one or more processors 1601 and memory 1602 configured to store computer executable instructions, where the processor 1601 is configured to perform the method for reconstructing a spectrum according to any one of above embodiments when the computer executable instructions are executed by the processor 1601.

The processor 1601 may be a central processing unit (CPU) or other form of processing unit with data transmission capability and/or instruction execution capability, and may control other components in the electronic device to perform the desired function.

The memory 1602 may include one or more computer program products, which may include various forms of computer-readable storage media, such as volatile memory and/or non-volatile memory. The volatile memory may include, for example, random access memory (RAM) and/or cache memory (Cache). The non-volatile memory may include, for example, read only memory (ROM), hard disk, flash memory and so on. One or more computer program instructions may be stored in a computer-readable storage medium, and the processor 1601 may run the program instructions to realize the steps and/or other desired functions in the method for reconstructing a spectrum according to the embodiments of the present application.

For example, the electronic device 1600 may also include an input device 1603 and an output device 1604. These components are interconnected by a bus system and/or other forms of connection mechanism (not shown in FIG. 23).

In addition, the input device 1603 may also include, for example, a keyboard, a mouse, a microphone and so on.

The output device 1604 may output various information to the outside. The output device 1604 may include, for example, a display, a speaker, a printer, a communication network and a remote connected output device, and so on.

In order to simplify, only some of the components related to the present application in the electronic device 1600 are shown in FIG. 23 and components such as bus, input device/output interface and so on are omitted. In addition, the electronic device 1600 may also include any other appropriate components according to the specific application.

Beyond the above methods and devices, the embodiments of the present application may also be computer program products, including computer program instructions, which enable the processor to perform the steps in the method for reconstructing a spectrum as described in any one of above embodiments when run by the processor.

The computer program product may write program code for executing the operation of the embodiments of the present application in any combination of one or more programming languages. The programming languages include object-oriented programming languages, such as Java, C++, and also include conventional procedural programming languages, such as “C” language or similar programming languages. The program code may be completely executed on the user's computing device, partially executed on the user's device, executed as an independent software package, partially executed on the user's computing device and partially executed on the remote computing device, or completely executed on the remote computing device or processor.

In addition, the embodiments of the present application may also be a computer-readable storage medium on which computer executable instructions are stored. When the computer executable instructions are run by the processor, the processor performs the steps of the method for reconstructing a spectrum described in the “exemplary method” according to the embodiments of the present application.

The computer-readable storage medium may adopt any combination of one or more readable media. The readable medium may be a readable signal medium or a readable storage medium. The readable storage medium may include, for example, but not limited to, systems, apparatuses or means of electricity, magnetism, light, electromagnetism, infrared ray, or semiconductor, or any combination of the above. More specific examples of readable storage media (not an exhaustive list) include: electronic connection with one or more wires, portable disk, hard disk, RAM, ROM, erasable programmable read only memory (EPROM) or flash memory, optical fiber, compact disk read only memory (CD-ROM), optical storage means, magnetic storage means, or any suitable combination of the above.

The above describes the basic principle of the present application with reference to specific embodiments. However, it should be noted that the advantages, superiorities, effects and so on mentioned in the present application are only examples, but not limitations. It cannot be considered that these advantages, superiorities, effects and so on are necessary for each embodiment of the present application. In addition, the specific details disclosed above are only for the purpose of example and easy understanding, but not for limitation. The present application is not limited to the above specific details.

The block diagrams of means, apparatuses, devices and systems involved in the present application are only illustrative examples and are not intended to require or imply that they must be connected, disposed and configured in the manner shown in the block diagram. As those skilled in the art will recognize, these means, apparatuses, devices and systems can be connected, disposed and configured in any way. The terms such as “include”, “contain”, “have” and so on are open-class words, and referring to “include but not limited to”, and can be used interchangeably. The terms “or” and “and” refer to the terms “and/or” and can be used interchangeably, unless the context clearly indicate otherwise. The term “such as” refers to the terms “such as but not limited to” and can be used interchangeably.

It should also be noted that each component or step in the apparatuses, devices and methods of the present application can be decomposed and/or reassembled. The decomposition and/or recombination shall be considered as the equivalent of the present application.

The above description of the disclosed aspects is provided to enable any person skilled in the art to make or use the present application. Any modification to these aspects is obvious to a person skilled in the art, and the general principles defined herein can be applied to other aspects without departing from the protection scope of the present application. Therefore, the present application is not intended to be limited to the aspects shown herein, but to the widest range consistent with the principles and novel features disclosed herein.

The above description has been given for the purpose of illustration and description. In addition, the description is not intended to limit the embodiments of the present application to the form disclosed herein. Although several example aspects and embodiments have been discussed above, a person skilled in the art may recognize certain variations, modifications, changes, additions and sub-combinations thereof.

The above-mentioned embodiments are only the preferred embodiments of the present application, and are not intended to limit the protection scope of the present application. Any modification, equivalent replacement and so on made in the spirit and principle of the present application shall fall into the protection scope of the present application.

What is claimed is:

1. A method for reconstructing a spectrum, applied to a spectrometer, comprising:
determining spectral data to be processed; and
acquiring positive spectral data by converting, by an objective function, a negative spectral value in the spectral data to be processed into a positive spectral value, determining a loss value by performing, by the objective function, loss calculation based on the positive spectral data and response value data, and acquiring reconstructed spectral data when the loss value meets a first preset condition or a number of the loss calculation meets a second preset condition, wherein the response value data is obtained by measuring, by the spectrometer, a spectrum to be reconstructed.

2. The method for reconstructing the spectrum according to claim 1, wherein the acquiring positive spectral data by converting, by an objective function, a negative spectral value in the spectral data to be processed into a positive spectral value, determining a loss value by performing, by the objective function, loss calculation based on the positive spectral data and response value data, and acquiring reconstructed spectral data when the loss value meets a first preset condition or a number of the loss calculation meets a second preset condition comprises:
acquiring current positive spectral data by converting, by the objective function, the negative spectral value in current spectral data to be processed into the positive spectral value;
determining, by the objective function, a current loss value and current reconstructed spectral data based on the current positive spectral data and the response value data; and
adjusting the spectral data to be processed based on the current loss value and the current reconstructed spectral data, iterating the spectral data to be processed, and acquiring the reconstructed spectral data until the loss value meets the first preset condition or the number of the loss calculation meets the second preset condition.

3. The method for reconstructing the spectrum according to claim 2, wherein the acquiring current positive spectral data by converting, by the objective function, the negative spectral value in current spectral data to be processed into the positive spectral value comprises:
acquiring the current positive spectral data by converting, by the objective function, the negative spectral value in the current spectral data to be processed into the positive spectral value by taking an absolute value of the current spectral data to be processed.

4. The method for reconstructing the spectrum according to claim 2, wherein the acquiring current positive spectral data by converting, by the objective function, the negative spectral value in current spectral data to be processed into the positive spectral value comprises:
determining a symbol diagonal matrix of the current spectral data to be processed; and
acquiring the current positive spectral data by converting, by the objective function, the negative spectral value in the current spectral data to be processed into the positive spectral value by taking a product of the current spectral data to be processed and the symbol diagonal matrix.

5. The method for reconstructing the spectrum according to claim 2, wherein the determining spectral data to be processed comprises:
determining the current spectral data to be processed corresponding to the (k+2)^{th} cycle based on current reconstructed spectral data obtained from the k^{th} cycle and current reconstructed spectral data obtained from the (k+1)^{th} cycle, wherein k is a positive integer.

6. The method for reconstructing the spectrum according to claim 5, wherein the determining the current spectral data to be processed corresponding to the (k+2)^{th} cycle based on current reconstructed spectral data obtained from the k^{th} cycle and current reconstructed spectral data obtained from the (k+1)^{th} cycle comprises:
acquiring difference data by calculating a difference between the current reconstructed spectral data obtained from the (k+1)^{th} cycle and the current reconstructed spectral data obtained from the k^{th} cycle; and
determining the current spectral data to be processed corresponding to the (k+2)^{th} cycle based on the current reconstructed spectral data obtained from the (k+1)^{th} cycle, the difference data, and a preset return function.

7. The method for reconstructing the spectrum according to claim 2, wherein the determining, by the objective function, a current loss value and current reconstructed spectral data based on the current positive spectral data and the response value data comprises:
acquiring current preprocessed spectral data by preprocessing, by the objective function, the current positive spectral data; and
determining the current loss value and the current reconstructed spectral data by performing, by the objective function, loss calculation based on the current preprocessed spectral data and the response value data.

8. The method for reconstructing the spectrum according to claim 1, wherein the objective function comprises:
$${min}_{S} {‖ I - TQ \vert {X}_{k} \vert ‖}^{2} + α {‖ {LX}_{k} ‖}_{n}^{m}$$
wherein I represents the response value data, T represents a reconstruction matrix, Q represents a preprocessing matrix, L represents a regularization matrix, Xₖ represents the current spectral data to be processed corresponding to the k^{th} cycle, α∥LXₖ∥ₙ^{m} represents a regularization term, α represents a regularization coefficient, m represents idempotent, and n represents a type of a norm.

9. The method for reconstructing the spectrum according to claim 1, wherein the first preset condition is a preset threshold.

10. The method for reconstructing the spectrum according to claim 1, wherein the second preset condition is a preset number of the loss calculation.

11. A device for reconstructing a spectrum, applied to a spectrometer, comprising:
a determination module, configured to determine spectral data to be processed; and
a reconstruction module, configured to acquire positive spectral data by converting, by an objective function, a negative spectral value in the spectral data to be processed into a positive spectral value, determining a loss value by performing, by the objective function, loss calculation based on the positive spectral data and response value data, and acquiring reconstructed spectral data when the loss value meets a first preset condition or a number of the loss calculation meets a second preset condition, wherein the response value data is obtained by measuring, by the spectrometer, a spectrum to be reconstructed.

12. A spectrometer, comprising:
a detector, configured to acquire response value data by measuring a spectrum to be reconstructed, and send the response value data to a processor; and
the processor electrically connected with the detector, configured to receive the response value data, and acquire reconstructed spectral data by performing the method for reconstructing a spectrum according to claim 1.

13. A non-transitory computer-readable storage medium, on which instructions are stored, wherein when the instructions are executed by a processor of an electronic device, the electronic device is able to perform the method for reconstructing a spectrum according to claim 1.

14. An electronic device, comprising:
a processor; and
a memory, configured to store computer executable instructions;
wherein the processor is configured to perform the computer executable instructions to implement the method for reconstructing a spectrum according to claim 1.
